(19) United States
(12) Patent Application Publication
(10) Pub. No.: US 2026/0295464 A1
(43) Pub. Date: Oct. 1, 2026

(54) OIL SEPARATOR STRUCTURE FOR BLOW-BY GAS RECIRCULATION SYSTEM, AND VEHICLE

(71) Applicant: ISUZU MOTORS LIMITED, Yokohama-shi (JP)

(72) Inventor: Hiroyuki YUZA, Fujisawa-shi (JP)

(21) Appl. No.: 19/536,350

(22) Filed: Feb. 11, 2026

(30) Foreign Application Priority Data
Mar. 26, 2025 (JP) 2025-052285

(51) Int. Cl. B01D 17/02; B01D 19/00; B01D 46/00; F01M 13/02; F01M 13/04; F01M 11/00; F01M 13/00

(52) U.S. Cl. CPC B01D 17/0211; B01D 19/0042; B01D 19/0057; B01D 46/0031; F01M 13/022; F01M 13/04; F01M 13/0416; F01M 2011/007; F01M 2013/0044; F01M 2013/0427; F01M 2013/0461; F01M 2013/0488

(57) ABSTRACT

In oil separator structure A of the blow-by gas recirculation system according to the present disclosure, baffle plate 10 has recessed oil reservoir 11 that stores oil separated from the blow-by gas in oil separation chamber Ax, Ay, and oil drop hole 12 that returns the oil stored in oil reservoir 11 to cam chamber 100X. Upper cover plate 13U is disposed on the upper surface of baffle plate 10, covering oil reservoir 11 from above, and lower cover plate 13D is disposed on the lower surface of baffle plate 10, covering oil drop hole 12 from below.

### TECHNICAL FIELD

This disclosure relates to an oil separator structure for a blow-by gas recirculation system, and a vehicle.

### BACKGROUND ART

A conventional blow-by gas recirculation system is known that recirculates blow-by gas generated in the crankcase of an internal combustion engine to the intake side. Such a blow-by gas recirculation system is usually provided with an oil separator structure to separate and remove oil components, such as lubricating oil, contained in the blow-by gas before the blow-by gas is recirculated to the intake side.

One known structure of such an oil separator is one in which the upper part of the cam chamber inside the cylinder head cover is covered with a baffle plate, and an oil separation chamber (also called a breather chamber or PCV chamber) is formed between the inner wall of the cylinder head cover and the baffle plate to collect blow-by gas from the space above the cylinder head, and the oil separated in this oil separation chamber is returned to the cylinder head side (see, for example, PTL 1).

In a blow-by gas recirculation system with such an oil separator structure, the downstream end of the oil separation chamber is connected to, for example, the intake side of the internal combustion engine, thereby introducing negative pressure into the downstream side of the oil separation chamber. This negative pressure is used to collect blow-by gas from the space above the cylinder head into the oil separation chamber. As the collected blow-by gas is guided from the upstream side to the downstream side of the oil separation chamber, it collides with a guide wall provided in the oil separation chamber, causing the oil in the gas to drip onto the wall surface of the baffle plate and be separated. The blow-by gas from which the oil has been separated and removed is then recirculated to the intake side of the internal combustion engine.

### Citation List

### Patent Literature

PTL 1: Japanese Patent Application Laid-Open No. 2005-120855

### SUMMARY OF INVENTION

### Technical Problem

Such an oil separator structure typically has an oil reservoir formed on the upper surface of the baffle plate, and an oil drop hole formed within this oil reservoir to return the stored oil to the cam chamber. The oil separated in the oil separation chamber is returned to the cylinder head (i.e., the cam chamber) via the oil drop hole.

However, as a result of diligent research by the inventors of the present application, it has been found that in oil separator structure according to the conventional structure, there is a risk that blow-by gas in the space above the cylinder head may be blown directly into the oil reservoir through the oil drop hole without passing through the oil separation mechanism (i.e., the separation passage formed by the guide wall) in the oil separation chamber.

When the blow-by gas intensifies, the oil stored in the oil reservoir is blown up into the oil separation chamber, and a large amount of this oil is returned to the intake side together with the blow-by gas. Also, when there is no oil stored in the oil reservoir, oil mist is blown into the oil separation chamber together with the blow-by gas through the oil drop hole.

If such a situation occurs, it will deteriorate the exhaust gas emissions from the engine. Additionally, the engine oil consumption (LOC) will also increase.

The present invention has been made in view of the above-mentioned problems. That is, an object of the present invention is to provide an oil separator structure for a blow-by gas recirculation system, and a vehicle, that can more effectively suppress the recirculation of oil from the oil separation chamber to the intake side.

### Solution to Problem

A main aspect of the present disclosure for solving the above-described problems is an oil separator structure for a blow-by gas recirculation system of an internal combustion engine, in which an upper part of a cam chamber in a cylinder head cover is covered with a baffle plate, and an oil separation chamber is formed to collect blow-by gas from an upper space in the cylinder head and separate oil contained in the blow-by gas, wherein

the baffle plate has a recessed oil reservoir that stores oil separated from the blow-by gas in the oil separation chamber, and an oil drop hole that returns the oil stored in the oil reservoir to the cam chamber,

an upper cover plate is disposed on an upper surface of the baffle plate, covering the oil reservoir from above, and

a lower cover plate is disposed on a lower surface of the baffle plate, covering the oil drop hole from below.

In another aspect, it is a vehicle having the oil separator structure.

### Advantageous Effects of Invention

According to the oil separator structure for a blow-by gas recirculation system of the present invention, it is possible to more effectively suppress the recirculation of oil from the oil separation chamber to the intake side.

### BRIEF DESCRIPTION OF DRAWINGS

FIG. 1 is a perspective view of a cylinder head cover according to one embodiment of the present invention as seen from above.

FIG. 2 is a perspective view of a baffle plate according to one embodiment of the present invention as seen from the back side of the cylinder head cover.

FIG. 3 is a plan view of a baffle plate according to one embodiment of the present invention as seen from the back side of the cylinder head cover.

FIG. 4 is an enlarged perspective view of an oil return structure formed on the baffle plate according to one embodiment of the present invention.

FIG. 5 is an enlarged vertical cross-sectional view of an oil return structure formed on the baffle plate according to one embodiment of the present invention.

FIG. 6 is an enlarged vertical cross-sectional view of the oil return structure formed on the baffle plate according to one embodiment of the present invention.

### DESCRIPTION OF EMBODIMENTS

Hereinafter, a preferred embodiment of the present invention will be described in detail with reference to the accompanying drawings. Note that, in the present specification and drawings, components having substantially the same functions are denoted by the same reference signs, and redundant descriptions are omitted thereby.

An oil separator structure for a blow-by gas recirculation system according to one embodiment of the present invention (hereinafter referred to as "oil separator structure A") will be described below. Oil separator structure A according to this embodiment is applicable to, for example, any internal combustion engine (e.g., a diesel engine, a gasoline engine, a natural gas engine, a hydrogen engine, an ethanol engine, or an engine that uses ammonia as fuel), and is mounted on a vehicle together with the internal combustion engine.

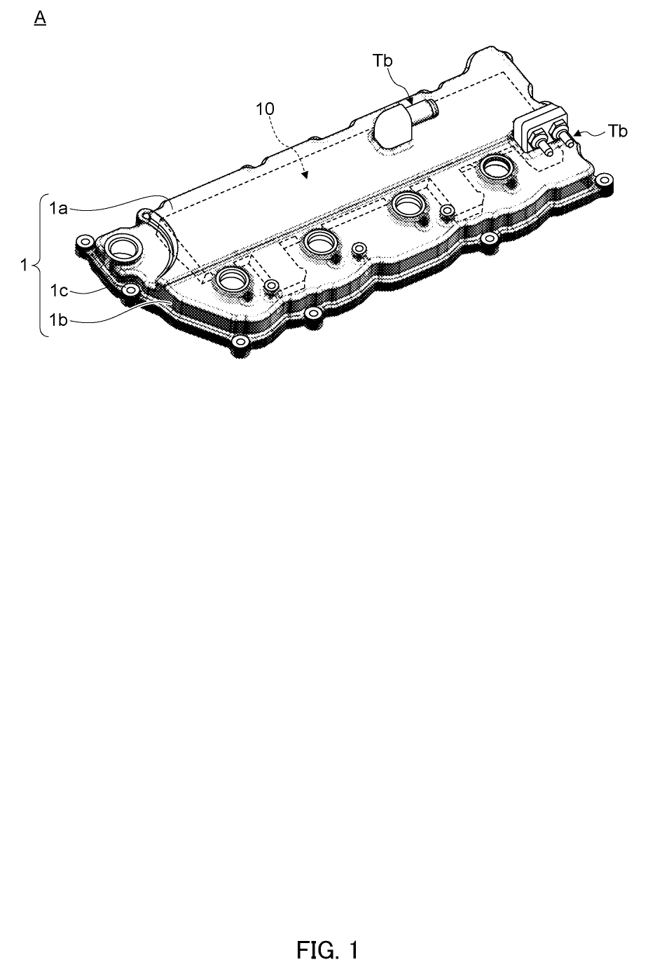

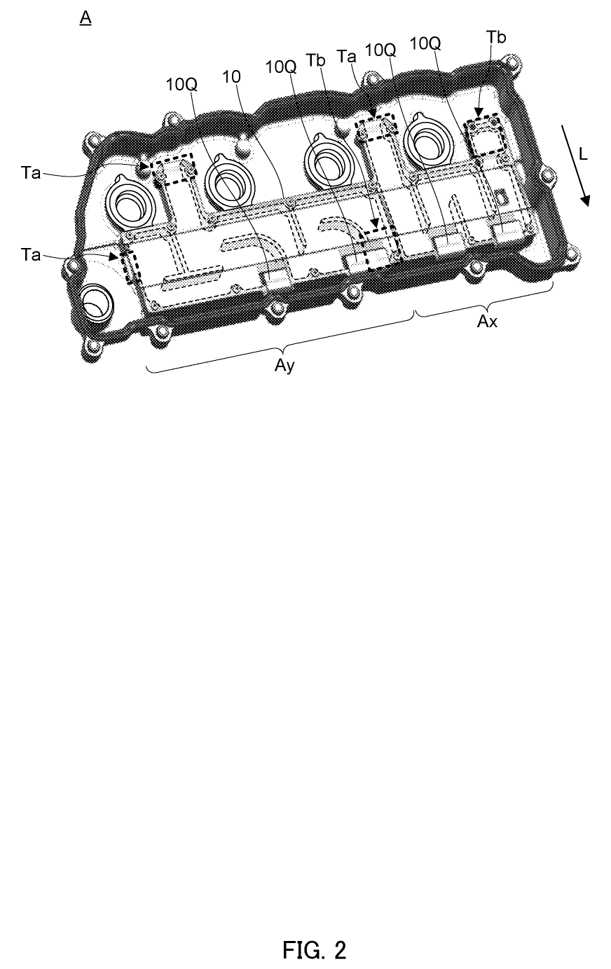

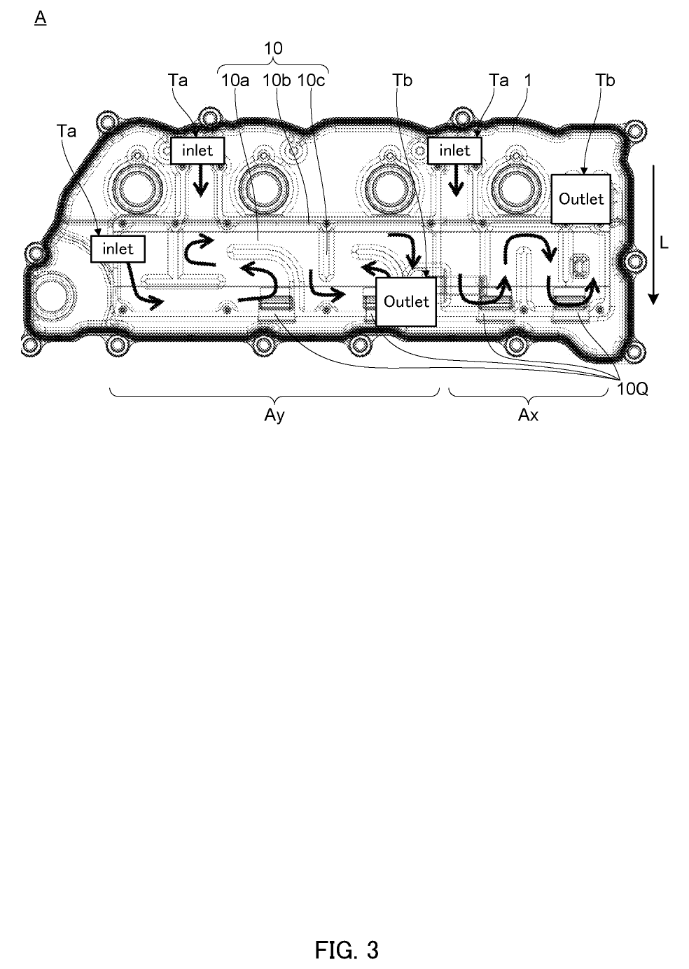

FIG. 1 is a perspective view of cylinder head cover 1 as seen from above. FIG. 2 is a perspective view of baffle plate 10 as seen from the rear side of cylinder head cover 1. FIG. 3 is a plan view of baffle plate 10 as seen from the rear side of cylinder head cover 1. The arrows in FIG. 3 indicate the flow paths of blow-by gas in oil separation chambers Ax and Ay.

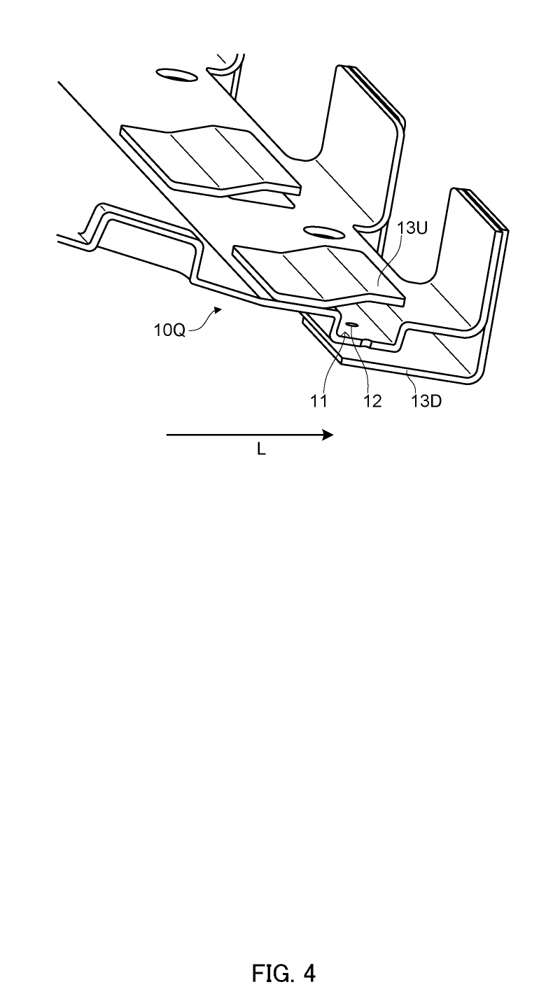

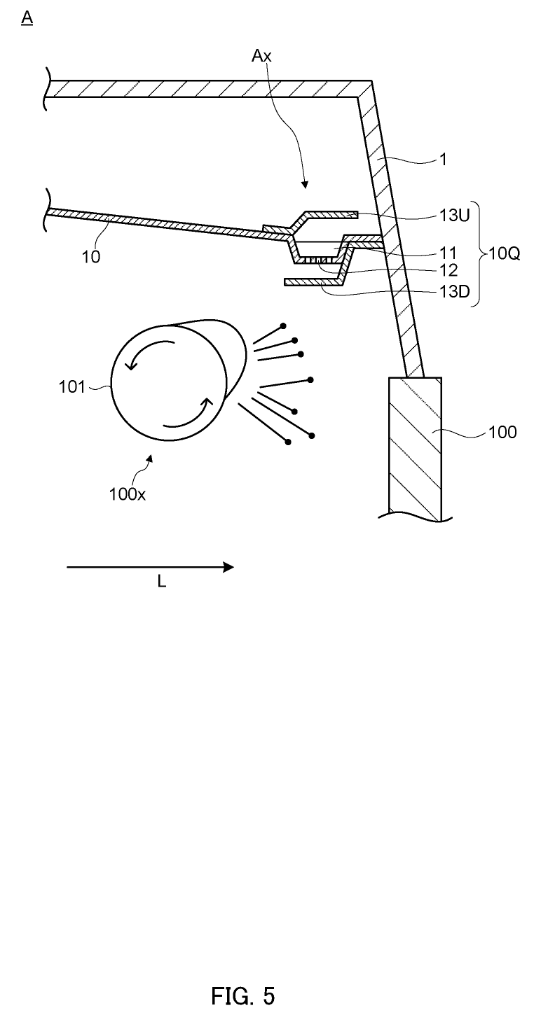

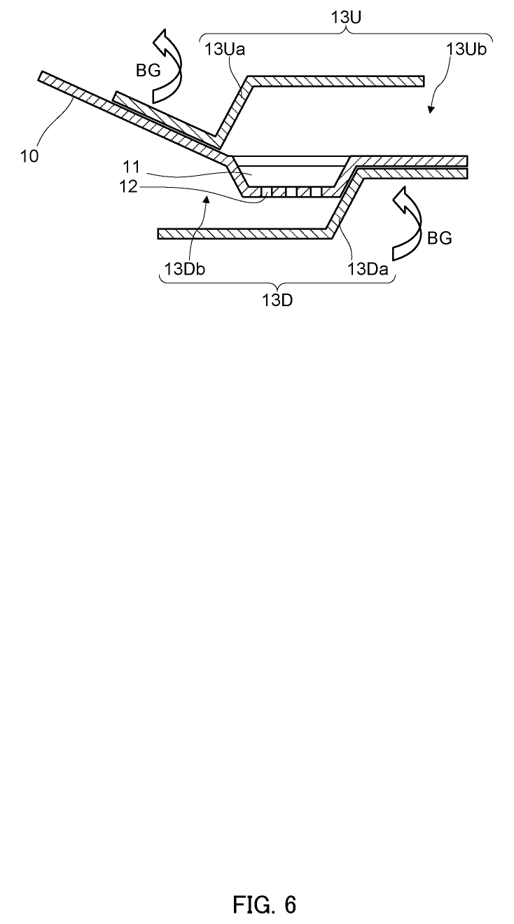

FIG. 4 is an enlarged perspective view of oil return structure 10Q formed in baffle plate 10. FIGS. 5 and 6 are enlarged vertical cross-sectional views of oil return structure 10Q formed in baffle plate 10. FIG. 5 illustrates a state in which oil separation chamber Ax is formed by baffle plate 10 in the space above cylinder head 100 (i.e., cam chamber 100x).

First, the overall configuration of oil separator structure A will be described with reference to FIGS. 1 to 3.

Oil separator structure A covers the upper part of cam chamber 100x inside cylinder head cover 1 with baffle plate 10, and forms oil separation chambers Ax and Ay between the inner wall of cylinder head cover 1 and baffle plate 10 to collect blow-by gas from the space above cylinder head 100. The oil separated in these oil separation chambers Ax and Ay is then returned to cam chamber 100x.

In oil separator structure A according to this embodiment, oil separation chambers Ax and Ay are formed as PCV (Positive Crankcase Ventilation) chamber Ax, which is connected to a downstream passage of the intake pipe of the internal combustion engine, and a breather chamber Ay, which is connected to an upstream passage of the intake pipe of the internal combustion engine. PCV chamber Ax and breather chamber Ay are formed as separate spaces separated from each other by side walls within baffle plate 10 (i.e., there is no gas flow between them).

PCV chamber Ax mainly collects blow-by gas from the space above cylinder head 100 and returns the blow-by gas to the downstream passage of the intake pipe (e.g., downstream of a turbocharger) when the internal combustion engine is operating under low load, while breather chamber Ay mainly collects blow-by gas from the space above cylinder head 100 and returns the blow-by gas to the upstream passage of the intake pipe (e.g., upstream of a turbocharger) when the internal combustion engine is operating under high load.

Since PCV chamber Ax and breather chamber Ay have substantially the same configuration, for the sake of convenience, only the configuration of PCV chamber Ax will be described below.

The blow-by gas recirculation system having a PCV chamber and a breather chamber as the oil separation chamber is particularly suitable for use in an internal combustion engine (e.g., a gasoline engine or a natural gas engine) that uses the Otto cycle.

Cylinder head cover 1 includes ceiling portion 1a formed in a substantially rectangular shape in a plan view, four side wall portions 1b hanging down from the periphery of ceiling portion 1a, and flange portion 1c extending substantially horizontally from the lower end of side wall portion 1b. Cylinder head cover 1 is attached to cylinder head 100 (see FIG. 5) by fitting a seal member into a groove in the underside of flange portion 1c and then bolting flange portion 1c to the upper side edge of cylinder head 100.

Baffle plate 10 is attached to the back side of cylinder head cover 1. More specifically, baffle plate 10 has bottom plate 10a and surrounding wall 10b standing upright from the edge of bottom plate 10a, and the upper end of surrounding wall 10b is attached by welding or the like to ceiling 1a of cylinder head cover 1. As a result, tunnel-shaped oil separation chamber Ax is formed between baffle plate 10 and the inner wall of cylinder head cover 1.

Bottom plate 10a of baffle plate 10 has gas inlet Ta that opens into the upper space of cylinder head 100. Blow-by gas in the space above cylinder head 100 flows into oil separation chamber Ax through gas inlet port Ta.

Ceiling portion 1a of cylinder head cover 1 has gas outlet Tb. The blow-by gas that flows into oil separation chamber Ax is returned to the intake pipe of the internal combustion engine via gas outlet Tb. PCV (Positive Crankcase Ventilation) valve (see FIG. 1) is attached to gas outlet Tb, and the blow-by gas that flows into oil separation chamber Ax is returned to the intake pipe of the internal combustion engine via the PCV valve.

Baffle plate 10 also has guide wall 10c standing upright from bottom plate 10a, which forms a guide path for blow-by gas within oil separation chamber Ax. Guide wall 10cis arranged to guide the blow-by gas that has flowed in from gas inlet Ta to gas outlet Tb while making the flow path snake within oil separation chamber Ax.

In this way, oil separation chamber Ax is a closed space between gas inlet Ta and gas outlet Tb. By connecting oil separation chamber Ax to the intake side of the internal combustion engine via gas outlet Tb, negative pressure is introduced into oil separation chamber Ax, and this negative pressure is used to collect blow-by gas from the space above cylinder head 100 into oil separation chamber Ax.

The blow-by gas is then collected in oil separation chamber Ax from the space above cylinder head 100 and guided by guide wall 10c from gas inlet Ta of oil separation chamber Ax to gas outlet Tb. During this process, the oil in the blow-by gas collides with guide wall 10c provided in oil separation chamber Ax and drips onto bottom plate 10a of baffle plate 10. The blow-by gas from which the oil has been separated and removed in this way is recirculated to the intake side of the internal combustion engine via gas outlet Tb (i.e., the PCV valve).

When the internal combustion engine is mounted on a vehicle or the like (hereinafter referred to as the "position in use"), bottom plate 10a of baffle plate 10 is disposed so that it is inclined downward at a predetermined angle, as indicated by the arrow L in FIGS. 2 and 3. Because bottom plate 10a of baffle plate 10 is inclined in this manner, oil that collides with guide wall 10c and drips onto bottom plate 10a (i.e., oil separated from the blow-by gas) flows along bottom plate 10a to the closed end on the lower side of baffle plate 10.

Oil return structure 10Q is formed at the closed end on the lower side of baffle plate 10 to return the oil separated from the blow-by gas in oil separation chamber Ax to cam chamber 100x.

Next, the configuration of oil return structure 10Q will be described in detail with reference to FIGS. 4 to 6.

Oil return structure 10Q comprises oil reservoir 11, oil drop hole 12, upper cover plate 13U, and lower cover plate 13D. Note that in FIG. 6, the flow of the blow-by gas is depicted with arrows BG.

Oil reservoir 11 is a concave groove formed in the upper surface of bottom plate 10a of baffle plate 10, and stores the oil separated from the blow-by gas in oil separation chamber Ax. As described above, bottom plate 10a of baffle plate 10 is disposed so as to be inclined downward at a predetermined angle when the internal combustion engine is in use. Therefore, the oil separated from the blow-by gas in oil separation chamber Ax flows along bottom plate 10a toward the closed end on the lower side of baffle plate 10 and accumulates in oil reservoir 11.

Oil drop hole 12 is a hole disposed inside oil reservoir 11 so as to penetrate vertically through bottom plate 10a of baffle plate 10, and returns the oil collected in oil reservoir 11 to cam chamber 100x.

Oil drop hole 12 is preferably formed in a circular shape with a diameter of 0.5 mm or more and less than 2.5 mm. This allows an oil film to be formed in oil drop hole 12 due to the surface tension of the oil, allowing the oil to be kept stored in oil reservoir 11 for a long period of time. By keeping the oil stored in oil reservoir 11, it is possible to prevent oil mist from being blown into oil separation chamber Ax together with the blow-by gas through oil drop hole 12.

Upper cover plate 13U is a plate member disposed on the upper surface of baffle plate 10 so as to cover oil reservoir 11 from above.

More specifically, upper cover plate 13U forms first shielding portion 13Ua with respect to the inside of oil separation chamber Ax and first opening 13Ub with respect to the outside of oil separation chamber Ax (see FIG. 6). First shielding portion 13Ua prevents blow-by gas flowing through oil separation chamber Ax from being blown into oil reservoir 11. First opening 13Ub is a region that serves as a passage through which oil separated from the blow-by gas in oil separation chamber Ax flows into oil reservoir 11.

Upper cover plate 13U acts to prevent the oil stored in oil reservoir 11 from being carried away by the blow-by gas flowing through oil separation chamber Ax. In particular, when the negative pressure generated in oil separation chamber Ax is large, blow-by gas may be blown up from oil drop hole 12 side, and the oil stored in oil reservoir 11 may be blown up together with the blow-by gas. Even in such a case, upper cover plate 13U is disposed so as to cover oil drop hole 12 from above, and therefore upper cover plate 13U can prevent the oil stored in oil reservoir 11 from being blown up.

Furthermore, when the flow of blow-by gas through oil separation chamber Ax is strong, the oil stored in oil reservoir 11 may be vaporized by the high-temperature blow-by gas and carried away directly, but this condition is also suppressed by first shielding portion 13Ua of upper cover plate 13U.

Lower cover plate 13D is a plate member disposed on the lower surface of baffle plate 10 so as to cover oil drop hole 12 from below.

More specifically, lower cover plate 13D forms a second shielding portion 13Da with respect to the outside of cam chamber 100x and a second opening 13Db with respect to the inside of cam chamber 100x (see FIG. 6). Second shielding portion 13Da prevents blow-by gas in the cam chamber 100x from being blown into oil drop hole 12. Second opening 13Db is a passage that allows oil that falls from oil drop hole 12 to return to cam chamber 100x.

When no oil is stored in the oil reservoir 11, lower cover plate 13D prevents oil mist, which rises from the space above cylinder head 100 toward oil drop hole 12, from passing through oil drop hole 12 together with blow-by gas and flowing into oil separation chamber Ax. Generally, oil mist rising from the space above cylinder head 100 toward oil drop hole 12 arrives toward oil drop hole 12 from outside of cam chamber 100x together with blow-by gas, due to its relationship with the rotation direction of cam 101 in cam chamber 100x (see FIGS. 5 and 6 ). Second shielding portion 13Da of lower cover plate 13D prevents blow-by gas from being blown toward oil drop hole 12 from outside of cam chamber 100x, thereby more effectively preventing oil mist from entering oil drop hole 12.

The oil that falls from oil drop hole 12 is returned to the inside of cam chamber 100x via second opening 13Db.

### Effects

In the above embodiment, oil separator structure A for the blow-by gas recirculation system of internal combustion engine, in which the upper part of cam chamber 100X in cylinder head cover 1 is covered with baffle plate 10, and oil separation chamber Ax, Ay is formed to collect blow-by gas from the upper space in the cylinder head and separate oil contained in the blow-by gas is disclosed.

### In this oil separator structure A

baffle plate 10 has recessed oil reservoir 11 that stores oil separated from the blow-by gas in oil separation chamber Ax, Ay, and oil drop hole 12 that returns the oil stored in the oil reservoir 11 to cam chamber 100X,

the upper cover plate 13U is disposed on the upper surface of baffle plate 10, covering the oil reservoir 11 from above, and

the lower cover plate 13D is disposed on the lower surface of baffle plate 10, covering the oil drop hole 12 from below.

Oil separator structure A according to this embodiment effectively prevents oil from flowing back from oil separation chambers Ax, Ay to the intake side, thereby improving exhaust gas emissions from the engine and engine oil consumption (LOC).

### Other Embodiments

The present invention is not limited to the above embodiments and can be applied to various modifications.

For example, in the above embodiment, both PCV chamber Ax and breather chamber Ay were described as having similar oil return structures 10Q. However, there are cases where the engine negative pressure generated in breather chamber Ay is not as great as that generated in PCV chamber Ax.

From this perspective, for example, it is also possible to provide upper cover plate 13U and lower cover plate 13D only in PCV chamber Ax.

Furthermore, in the above embodiment, oil separator structure A having PCV chamber Ax and breather chamber Ay is disclosed. However, such an oil separator structure A depends on the configuration of the blow-by gas recirculation system, and in realizing oil separator structure according to the present invention, only one of PCV chamber Ax and breather chamber Ay may be provided within baffle plate 10. For example, in the case of a diesel engine, the blow-by gas recirculation system may be configured to have only breather chamber Ay without providing PCV chamber Ax.

Although the specific examples of the present invention have been described in detail above, these are merely examples and do not limit the scope of the claims. The technology described in the claims includes various modifications and changes of the specific examples exemplified above.

This application is entitled to the benefit of Japanese Patent Application No.2025-52285, filed on March 26, 2025, the disclosure of which including the specification, drawings and abstract is incorporated herein by reference in its entirety.

### INDUSTRIAL APPLICABILITY

According to the oil separator structure of the blow-by gas recirculation system of the present invention, it is possible to more effectively suppress the recirculation of oil from the oil separation chamber to the intake side.

### REFERENCE SIGNS LIST

A. Oil Separator Structure

Ax. PCV Chamber (Oil Separation Chamber)

Ay. Breather Chamber (Oil Separation Chamber)

1. Cylinder Head Cover

10. Baffle Plate

10Q. Oil Return Structure

11. Oil Reservoir

12 Oil drop hole

13D. Lower Cover Plate

13Da. Second Shield Portion

13Db. Second Opening

13U. Upper Cover Plate

13Ua. First Shield Portion

13Ub. First Opening

100. Cylinder Head

100x. Cam Chamber

101. Cam

Ta. Gas Inlet

Tb. Gas Outlet

1. An oil separator structure for a blow-by gas recirculation system of an internal combustion engine, in which an upper part of a cam chamber in a cylinder head cover is covered with a baffle plate, and an oil separation chamber is formed to collect blow-by gas from an upper space in the cylinder head and separate oil contained in the blow-by gas, wherein
the baffle plate has a recessed oil reservoir that stores oil separated from the blow-by gas in the oil separation chamber, and an oil drop hole that returns the oil stored in the oil reservoir to the cam chamber,
an upper cover plate is disposed on an upper surface of the baffle plate, covering the oil reservoir from above, and
a lower cover plate is disposed on a lower surface of the baffle plate, covering the oil drop hole from below.

2. The oil separator structure according to claim 1, wherein the upper cover plate forms a first shielding portion with respect to the inside of the oil separation chamber and a first opening with respect to the outside of the oil separation chamber.

3. The oil separator structure according to claim 1, wherein the lower cover plate forms a second shielding portion with respect to the outside of the cam chamber and a second opening with respect to the inside of the cam chamber.

4. The oil separator structure according to claim 1, wherein the oil reservoir is disposed at a position that corresponds to a closed end on a lower side of the baffle plate when the internal combustion engine is in use.

5. The oil separator structure according to claim 1, wherein the oil drop hole has a circular shape with a diameter of 0.5 mm or more and less than 2.5 mm.

6. A vehicle having the oil separator structure according to claim 1.
